(19) United States
(12) Patent Application Publication
(10) Pub. No.: US 2022/0058214 A1
(43) Pub. Date: Feb. 24, 2022

(54) DOCUMENT INFORMATION EXTRACTION METHOD, STORAGE MEDIUM AND TERMINAL

(71) Applicant: SHENZHEN SEKORM COMPONENT NETWORK CO., LTD, Shenzhen, Guangdong (CN)

(72) Inventor: Mantang Chen, Shenzhen, Guangdong (CN)

(21) Appl. No.: 17/413,534

(22) PCT Filed: Dec. 28, 2018
(86) PCT No.: PCT/CN2018/124782

§ 371 Date: Jun. 11, 2021

(51) Int. Cl. G06F 16/33; G06F 16/35; G06F 16/383; G06F 40/134; G06K 9/00

(52) U.S. Cl. CPC G06F 16/3334; G06F 16/358; G06K 2209/01; G06F 40/134; G06K 9/00469; G06F 16/383

(57) ABSTRACT

The invention relates to a document information extraction method, a storage medium and a terminal. The method comprises: acquiring text information and text position information of a document, wherein the text information corresponds to the text position information; extracting a keyword from the text information by using a training morpheme classification template; setting a hyperlink corresponding to the keyword. Storing the keyword, a hyperlink corresponding to the keyword, text position information corresponding to the keyword, document attribute information of a document in which the keyword is located, and a keyword classification. The invention can extract professional term keywords, product keywords, category keywords and attribute keywords from the information source of the document in the vertical field, so that the document information can be more accurately searched, the search matching degree is improved, and the user search experience is improved.

### BACKGROUND OF THE INVENTION

### 1.Technical Field

The invention relates to the field of document retrieval, in particular to a document information extraction method, a storage medium and a terminal.

### 2. Description of Related Art

At present, there are two methods to extract text from documents. One is to use OCR recognition technology to convert documents into images, and then output the results after layout analysis, line character segmentation and text recognition; another method is to parse the document, extract the text information, and output the results directly. However, the above two methods focus on extracting the text of the document, and do not describe the vertical domain keywords, product keywords, category keywords, attribute keywords of the original document content, nor the relationship between the keywords. This has become a bottleneck restricting people's information retrieval in the vertical industry field. Therefore, the research of information extraction from document is very important.

### BRIEF SUMMARY OF THE INVENTION

The technical problem to be solved by the invention is to provide a document information extraction method, a storage medium and a terminal aiming at the defects of the prior art.

The technical proposal adopted by the invention to solve the technical problem is to construct a document information extraction method, which comprises the following steps:

acquiring text information and text position information of a document, wherein the text information corresponds to the text position information;

extracting a keyword from the text information by using a training morpheme classification template;

and setting a hyperlink corresponding to the keyword.

Further, in the document information extraction method of the present invention, the document is a PDF document, and the acquiring of the text information and the text position information of the document comprises:

identifying text information in the PDF document by using an optical character recognition method, and simultaneously acquiring position information and page number position information of the text information in a certain page in the document.

Further, according to the document information extraction method of the present invention, the text position information comprises x-axis information, y-axis information, and z-axis information of the text information, wherein the x-axis information and the y-axis information are position information of the text information in a certain page in the document, and the z-axis information is page number information of text information in the document.

Further, according to the document information extraction method of the present invention, wherein the extracting a keyword from the text information by using the training morpheme classification template comprises:

extracting a keyword from the text information by using a training morpheme list in the training morpheme classification template, the part of speech of the training morpheme list, the correlation between the training morpheme list and a preset resource, and a preset target morpheme.

Further, in the document information extraction method of the present invention, after extracting a keyword from the text information by using the training morpheme classification template and before setting a hyperlink corresponding to the keyword, the method further comprises:

carrying out keyword decoding and keyword classification on the keywords, wherein the keyword decoding refers to carrying out data decoding according to the file structure of the document; the keyword classification refers to classification according to a preset classification mode, wherein the preset classification mode comprises a professional term keyword mode, a product keyword mode, a category keyword mode and an attribute keyword mode.

Further, in the document information extraction method of the present invention, after setting the hyperlink corresponding to the keyword, the method further comprises:

storing the keyword, a hyperlink corresponding to the keyword, text position information corresponding to the keyword, document attribute information of a document in which the keyword is located, and keyword classification, wherein the document attribute information comprises a document title, a document generation date and a document version number.

Further, in the document information extraction method of the present invention, after storing the keyword, the hyperlink corresponding to the keyword, the text position information corresponding to the keyword, document attribute information of the document in which the keyword is located, and the keyword classification, the method further comprises:

receiving a keyword;

searching a search result corresponding to the keyword, wherein the search result comprises a document title, a document generation date, a document version number, a keyword, text position information corresponding to the keyword and a hyperlink corresponding to the keyword.

Further, in the document information extraction method of the present invention, after searching a search result corresponding to the keyword, the method further comprises:

opening the document where the keyword resides according to the hyperlink, and positioning and displaying the position of the keyword according to the text position information corresponding to the keyword.

In addition, the present invention also provides a computer-readable storage medium having stored there on a computer program which, when executed by a processor, realizes the document information extraction method as described above.

In addition, the invention also provides a terminal which comprises a processor and is used for realizing the steps of the document information extraction method when the computer program stored in the memory is executed.

The document information extraction method, the storage medium and the terminal have the advantages that the method comprises the following steps of: acquiring text information and text position information of a document, wherein the text information corresponds to the text position information; extracting a keyword from the text information by using a training morpheme classification template; setting a hyperlink corresponding to the keyword. Storing a keyword, a hyperlink corresponding to the keyword, text position information corresponding to the keyword, document attribute information of a document in which the keyword is located, and the keyword classification. The invention can extract professional term keywords, product keywords, category keywords and attribute keywords from the information source of the document in the vertical field, so that the document information can be more accurately searched, the search matching degree is improved, and the user search experience is improved.

BRIEF DESCRIPTION OF THE SEVERAL VIEWS OF THE DRAWINGS

Brief description of that drawing the invention will now be further described by way of example with reference to the accompany drawings in which:

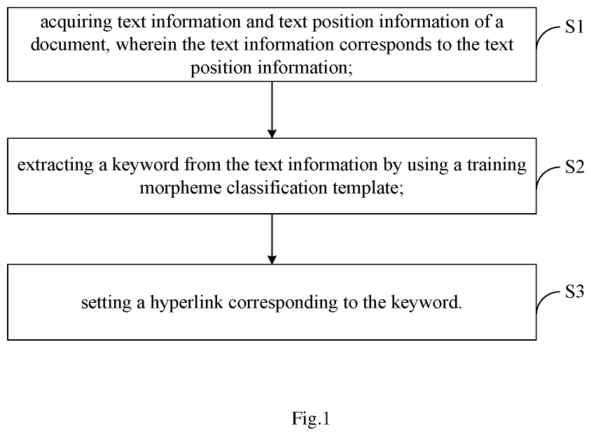

FIG. 1 is a flowchart of a document information extraction method according to an embodiment of the present invention;

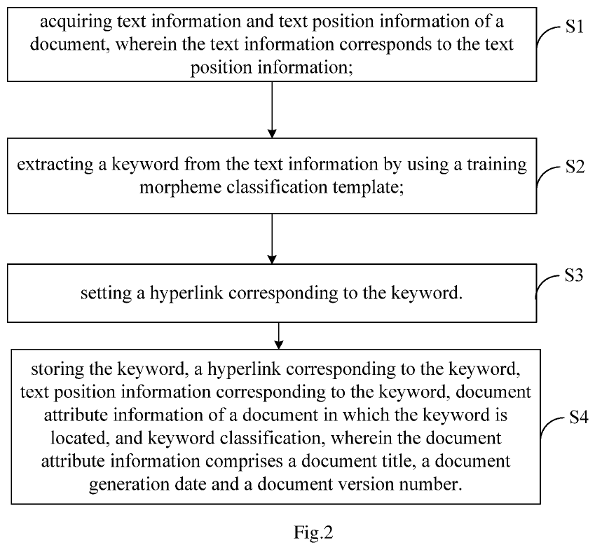

FIG. 2 is a flowchart of a document information extraction method according to an embodiment of the present invention;

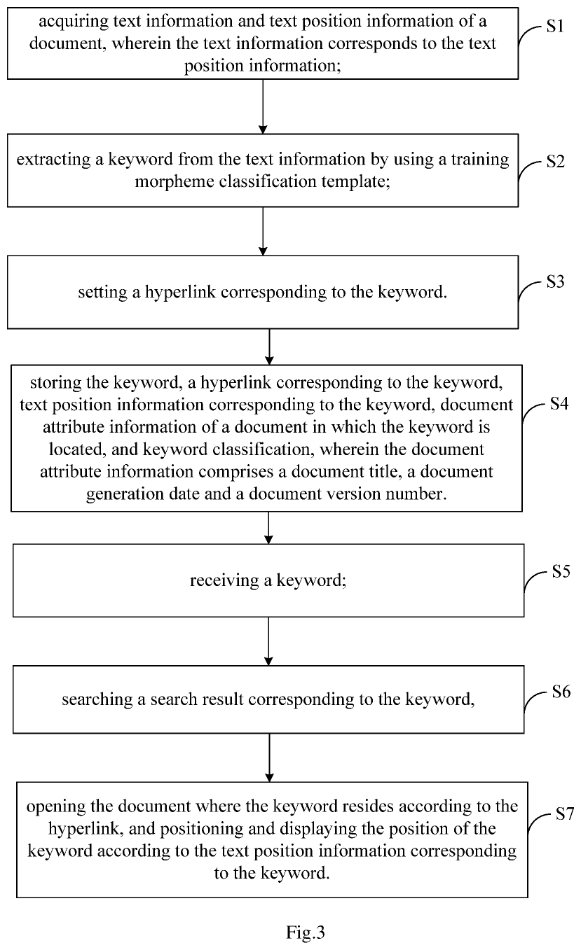

FIG. 3 is a flowchart of a document information extraction method according to an embodiment of the present invention;

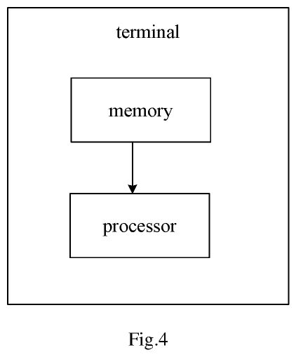

FIG. 4 is a schematic structural diagram of a terminal of the present invention.

### DETAILED DESCRIPTION OF THE INVENTION

For a clearer understanding of the technical features, objects and effects of the present invention, a detailed description will now be given of specific embodiments of the present invention with reference to the accompanying drawings.

### EXAMPLE

As shown in FIG. 1, the document information extraction method in this embodiment includes:

S1, acquiring text information and text position information of a document, wherein the text information corresponds to the text position information. Alternatively, that document include, but is not limited to, word document, PDF documents, excel documents, txt documents, PPT document, WPS documents and the like, which include text information. Each text information in a document needs a corresponding text position information, and the text information can be located through the text position information. Preferably, the document is a PDF document, and acquiring the text information and the text position information of the document comprises: identifying the text information in the PDF document by using an optical character recognition method, and simultaneously acquiring the position information of the text information in a certain page of the document and the page number position information.

Further, a coordinate system is established in the document, and the coordinate system comprises an X axis, a y axis and a Z axis, wherein the X axis and the y axis are positioned in each page of the document and used for positioning the position of text information in the page; the z-axis represents document page number information, which is used to locate the page number of the page where the text information is located. Therefore, each acquired text position information comprises x-axis information, y-axis information and z-axis information of the text information, wherein the x-axis information and the y-axis information are position information of the text information in a certain page in the document, and the z-axis information is page number information of the document. The position of the text information in the document can be positioned quickly and accurately through the x-axis information, the y-axis information and the z-axis information.

S2, extracting a keyword from that text information by use the training morpheme classification template. The training morpheme classification template is obtained by training and learning a training corpus containing various training morphemes, and comprises a training morpheme list, a part of speech of the training morpheme list, a correlation between the training morphology list and a preset resource, and a preset target morpheme. Therefore, extracting a keyword from the text information using the training morpheme classification template includes: extracting a keyword from the text information using a training morpheme list in the training morpheme classification template, a part of speech of the training morphology list, a correlation between the training morphology list and a preset resource, and a preset target morpheme.

Alternatively, the document information extraction method of this embodiment, after extracting a keyword from the text information using the training morpheme classification template and before setting the hyperlink corresponding to the keyword, further comprises:

carrying out keyword decoding and keyword classification on the keyword, wherein the keyword decoding refers to carrying out data decoding according to the file structure of the document; the keyword classification refers to classification according to a preset classification mode, wherein the preset classification mode comprises a professional term keyword mode, a product keyword mode, a category keyword mode and an attribute keyword mode.

S3, setting a hyperlink corresponding to the keyword. Hyperlinks are set for all the keywords extracted from the text information, the keywords and the hyperlinks are in one-to-one correspondence, and the hyperlinks comprise text position information corresponding to the text information, so that the positions of the keywords in the documents can be quickly located through the hyperlinks.

According to the embodiment of the invention, professional term keywords, product keywords, category keywords and attribute keywords can be extracted from the information source of the document in the vertical field, so that the document information can be searched more accurately.

### EXAMPLE

As shown in FIG. 2, on the basis of the above embodiment, after setting the hyperlink corresponding to the keyword, the document information extraction method of this embodiment further includes a step of storing the extracted information:

S4, establishing a database, and storing the keyword, a hyperlink corresponding to the keyword, text position information corresponding to the keyword, document attribute information of the documents where the keyword are located, and keyword classifications, wherein the document attribute information comprises a document title, a document generation date and a document version number. In the database, each keyword and the hyperlink corresponding to the keyword, the text position information corresponding to the keyword, the document attribute information of the document where the keyword is located, and the classification of the keyword form a piece of storage data. In the subsequent retrieval process, the keyword is used as the retrieval matching object, and the whole stored data can be obtained through keyword matching. It can be understood that the same keyword may exist in multiple pieces of stored data because multiple keywords may exist in the same document or the same keyword may exist in different documents.

Alternatively, the database may be stored on a separately located server or the database may be located on a cloud platform.

According to the embodiment of the invention, professional term keywords, product keywords, category keywords and attribute keywords can be extracted from the information source of the document in the vertical field, and a special database is established, so that the document information can be searched more accurately.

### EXAMPLE

As shown in FIG. 3, on the basis of the above embodiment, after storing the keyword, the hyperlink corresponding to the keyword, the text position information corresponding to the keyword, and the document attribute information of the document where the keyword is located, and the keyword classification, the document information extraction method in this embodiment further includes a retrieval step:

S5, receiving a keyword. Alternatively, the keyword may be received by an input device, or received and recognized by a voice receiving device, or received by a camera scanning a bar code or a two-dimensional code of an electronic component, etc.

S6, searching a search result corresponding to the keyword. The searching process is as follows: whether the received keyword is in the database is judged through matching or not, if the received keyword is matched with the keyword in the database, a piece of stored data corresponding to the keyword is read, and a search result is obtained. If the received keyword does not match the keyword in the database, the keyword data is not available. The search result includes a document title, a document generation date, a document version number, a keyword, text position information corresponding to the keyword, and a hyperlink corresponding to the keyword.

Alternatively, the document information extraction method of this embodiment, after searching for a search result corresponding to the keyword, further comprises a search result display step:

S7, opening that document where the keyword is located accord to the hyperlink, and positioning and displaying the position where the keyword is located accord to the text position information corresponding to the keyword. Each text position information comprises x-axis information, y-axis information and z-axis information of the text information, wherein the x-axis information and the y-axis information are position information of the text information in a certain page in the document, and the z-axis information is page number information of the document. The position of the text information in the document can be positioned quickly and accurately through the x-axis information, the y-axis information and the z-axis information.

Alternatively, if a plurality of pieces of keyword data are included in the search result, the search result is displayed in a predetermined sorting manner, for example, a display by the document creation date, a display according to the context of the keyword in the document, or a display preferentially displaying the keyword in the document having a high frequency according to the frequency of digital display of the keyword. The arrangement of display windows can be selected from superposition arrangement, window horizontal tiled arrangement, window vertical tiled arrangement and window checkerboard arrangement. For multiple keywords in the same document, they can be displayed through the split display window.

Alternatively, after that location of the displayed keyword is locate, the keywords may be highlighted by way of highlighting, underline, background color, etc to facilitate viewing by the user.

According to the embodiment of the invention, the professional term keyword, the product keyword, the category keyword and the attribute keyword can be extracted from the information source of the material document in the vertical field, and the document information can be searched more accurately through the keywords, so that the search matching degree is improved, and the user search experience is improved.

Alternatively, the above several document information extraction methods are applied to electronic component documents, where the electronic component documents include component parameter documents, component usage specification documents, order documents, component circuit documents and the like of the electronic components.

This embodiment also provides a computer-readable storage medium having stored there on a computer program that, when executed by a processor, realizes the document information extraction method as described above.

### EXAMPLE

As shown in FIG. 4, this embodiment also provides a terminal, the terminal includes a processor, and the processor is configured to implement the steps of the above document information extraction method when executing the computer program stored in the memory. Alternatively, terminals include, but are not limited to, smart phones, tablet computers, notebook computers, desktop computers, servers, and the like.

The invention can extract professional term keywords, product keywords, category keywords and attribute keywords from the information source of the document in the vertical field, so that the document information can be more accurately searched, the search matching degree is improved, and the user search experience is improved.

The embodiments are described in this specification in a progressive manner, with emphasis being placed on the differences between each embodiment and the other embodiments, and with reference to like parts of the embodiments. As for the device disclosed in the embodiment, since it corresponds to the method disclosed in the embodiment, the description is relatively simple, and the description of the related part can be referred to the method part.

Those skilled in the art will further appreciate that the example elements and algorithm steps described in connection with the embodiments disclosed herein can be implemented as electronic hardware, computer software, or a combination of both, and that the example components and steps have been described generally functionally throughout the foregoing description in order to clearly illustrate the interchangeability of hardware and software. Whether these functions are performed in hardware or software depends on the particular application and design constraints of the technical solution. Killed artisans may implement the described functionality using different approaches for each particular application, but such implementations should not be construed as beyond the scope of the present invention.

The steps of a method or algorithm described in connection with the embodiments disclosed herein may be embodied directly in hardware, in a software module executed by a processor, or in a combination of the two. A software module may reside in random access memory (RAM), memory, read only memory (ROM), electrically programmable ROM, electrically erasable programmable ROM, registers, hard disk, a removable disk, a CD-ROM, or any other form of storage medium known in the art.

The above embodiments are only for illustrating the technical concepts and feature of the present invention, and are intended to enable those skilled in the art to understand and implement the present invention, but not to limit the scope of protection of the present invention. All equivalent change and modifications that come within that scope of the append claims are intended to be embraced therein.

What is claimed is:

1. A document information extraction method, comprising:
acquiring text information and text position information of a document, wherein the text information corresponds to the text position information;
extracting a keyword from the text information by using a training morpheme classification template;
and setting a hyperlink corresponding to the keyword.

2. The document information extraction method according to claim 1, wherein the document is a PDF document, and the acquiring the text information and the text position information of the document comprises:
identifying text information in the PDF document by using an optical character recognition method, and simultaneously acquiring position information and page number position information of the text information in a certain page in the document.

3. The document information extraction method according to claim 1, wherein the text position information comprises x-axis information, y-axis information, and z-axis information of the text information, wherein the x-axis information and the y-axis information are position information of the text information in a page of the document, and the z-axis information is page number information of the text information in the document.

4. The document information extraction method according to claim 1, wherein the extracting a keyword from the text information by using a training morpheme classification template comprises:
extracting a keyword from the text information by using a training morpheme list in the training morpheme classification template, the part of speech of the training morpheme list, the correlation between the training morpheme list and a preset resource, and a preset target morpheme.

5. The document information extraction method according to claim 1, wherein after extracting a keyword from the text information by using the training morpheme classification template and before setting the hyperlink corresponding to the keyword, the method further comprises:
carrying out keyword decoding and keyword classification on the keywords, wherein the keyword decoding refers to carrying out data decoding according to the file structure of the document; the keyword classification refers to classification according to a preset classification mode, wherein the preset classification mode comprises a professional term keyword mode, a product keyword mode, a category keyword mode and an attribute keyword mode.

6. The document information extraction method according to claim 5, wherein after setting the hyperlink corresponding to the keyword, the method further comprises:
storing the keyword, a hyperlink corresponding to the keyword, text position information corresponding to the keyword, document attribute information of a document in which the keyword is located, and keyword classification, wherein the document attribute information comprises a document title, a document generation date and a document version number.

7. The document information extraction method according to claim 6, wherein after storing the keyword, the hyperlink corresponding to the keyword, the text position information corresponding to the keyword, document attribute information of the document in which the keyword is located, and the keyword classification, the method further comprises:
receiving a keyword;
searching a search result corresponding to the keyword, wherein the search result comprises a document title, a document generation date, a document version number, a keyword, text position information corresponding to the keyword and a hyperlink corresponding to the keyword.

8. The document information extraction method according to claim 7, wherein after searching a search result corresponding to the keyword, the method further comprises:
opening the document where the keyword resides according to the hyperlink, and positioning and displaying the position of the keyword according to the text position information corresponding to the keyword.

9. A computer-readable storage medium having a computer program stored thereon, wherein the computer program, when executed by a processor, implements the document information extraction method according to claim 1.

10. A terminal comprising a processor for implementing the steps of the document information extraction method according to claim 1 when executing a computer program stored in a memory.

11. The computer-readable storage medium according to claim 9, wherein the document is a PDF document, and the acquiring the text information and the text position information of the document comprises:
identifying text information in the PDF document by using an optical character recognition method, and simultaneously acquiring position information and page number position information of the text information in a certain page in the document.

12. The computer-readable storage medium according to claim 9, wherein the text position information comprises x-axis information, y-axis information, and z-axis information of the text information, wherein the x-axis information and the y-axis information are position information of the text information in a page of the document, and the z-axis information is page number information of the text information in the document.

13. The computer-readable storage medium according to claim 9, wherein the extracting a keyword from the text information by using a training morpheme classification template comprises:
extracting a keyword from the text information by using a training morpheme list in the training morpheme classification template, the part of speech of the training morpheme list, the correlation between the training morpheme list and a preset resource, and a preset target morpheme.

14. The computer-readable storage medium according to claim 9, wherein after extracting a keyword from the text information by using the training morpheme classification template and before setting the hyperlink corresponding to the keyword, the method further comprises:
carrying out keyword decoding and keyword classification on the keywords, wherein the keyword decoding refers to carrying out data decoding according to the file structure of the document; the keyword classification refers to classification according to a preset classification mode, wherein the preset classification mode comprises a professional term keyword mode, a product keyword mode, a category keyword mode and an attribute keyword mode.

15. The computer-readable storage medium according to claim 14, wherein after setting the hyperlink corresponding to the keyword, the method further comprises:
storing the keyword, a hyperlink corresponding to the keyword, text position information corresponding to the keyword, document attribute information of a document in which the keyword is located, and keyword classification, wherein the document attribute information comprises a document title, a document generation date and a document version number.

16. The terminal according to claim 10, wherein the document is a PDF document, and the acquiring the text information and the text position information of the document comprises:
identifying text information in the PDF document by using an optical character recognition method, and simultaneously acquiring position information and page number position information of the text information in a certain page in the document.

17. The terminal according to claim 10, wherein the text position information comprises x-axis information, y-axis information, and z-axis information of the text information, wherein the x-axis information and the y-axis information are position information of the text information in a page of the document, and the z-axis information is page number information of the text information in the document.

18. The terminal according to claim 10, wherein the extracting a keyword from the text information by using a training morpheme classification template comprises:
extracting a keyword from the text information by using a training morpheme list in the training morpheme classification template, the part of speech of the training morpheme list, the correlation between the training morpheme list and a preset resource, and a preset target morpheme.

19. The terminal according to claim 10, wherein after extracting a keyword from the text information by using the training morpheme classification template and before setting the hyperlink corresponding to the keyword, the method further comprises:
carrying out keyword decoding and keyword classification on the keywords, wherein the keyword decoding refers to carrying out data decoding according to the file structure of the document; the keyword classification refers to classification according to a preset classification mode, wherein the preset classification mode comprises a professional term keyword mode, a product keyword mode, a category keyword mode and an attribute keyword mode.

20. The terminal according to claim 19, wherein after setting the hyperlink corresponding to the keyword, the method further comprises:
storing the keyword, a hyperlink corresponding to the keyword, text position information corresponding to the keyword, document attribute information of a document in which the keyword is located, and keyword classification, wherein the document attribute information comprises a document title, a document generation date and a document version number.
